(19) United States
(12) Patent Application Publication
(10) Pub. No.: US 2015/0114060 A1
(43) Pub. Date: Apr. 30, 2015

(54) CLAMPING DEVICE, LOCKING CYLINDER ARRANGEMENT AND MOTOR VEHICLE

(71) Applicant: GM Global Technology Operations LLC, Detroit, MI (US)

(72) Inventors: Mark Rosenau, Schornsheim (DE); Ingo Eikens, Ruesselsheim (DE)

(21) Appl. No.: 14/522,417

(22) Filed: Oct. 23, 2014

(30) Foreign Application Priority Data
Oct. 25, 2013 (DE) 202013009474.5

(51) Int. Cl. E05B 79/04

(52) U.S. Cl. CPC E05B 79/04
USPC 70/431

(57) ABSTRACT

A clamping device for a locking cylinder arrangement of a motor vehicle is disclosed which includes a clamping body, a receptacle arranged on the clamping body for fixing a locking cylinder. A first retaining element is arranged on the clamping body. A cap covers the clamping device and is fixed by a second retaining element. A dismounting element cooperates with a release in order to detach the covering cap. The dismounting element includes an edge element extending in the direction of the covering cap and forming a hollow space. The dismounting element arranged on the clamping body is accessible from outside through a dismounting opening in the covering cap.

### CROSS REFERENCE TO RELATED APPLICATION

This application claims priority to German Patent Application No. 202013009474.5 filed Oct. 23, 2013, which is incorporated herein by reference in its entirety.

### TECHNICAL FIELD

The technical field pertains to a clamping device for a locking cylinder arrangement of a motor vehicle, a locking cylinder arrangement with such a clamping device and a motor vehicle with such a locking cylinder arrangement or clamping device.

### BACKGROUND

Locking cylinder arrangements for motor vehicles serve for securing a motor vehicle door or a swing panel or hatch of the motor vehicle against being inadvertently opened. To this end, a locking cylinder of the locking cylinder arrangement may be realized such that it can be activated mechanically and/or electrically, for example via radio, via infrared or by means of RFID technology. During the installation of the locking cylinder, it is inserted into a receptacle in the door or the hatch from the direction of the vehicle interior and fixed in its position from outside by means of a clamping device.

Conventional locking cylinder arrangements are provided with covering caps that are clipped to the clamping device in order to protect the locking cylinder and the clamping device from environmental influences and to optically cover the locking cylinder and the clamping device at least toward the outside. In order to detach the covering cap during maintenance work and/or repairs, conventional covering caps are provided with installation openings, through which a dismounting means or release tool such as, e.g., a vehicle key can be inserted and the covering cap can be attached and detached.

In this respect, it proved disadvantageous that air can penetrate the dismounting openings in the covering caps during the operation of the motor vehicle and be admitted into the vehicle interior through the locking cylinder arrangement.

It was attempted to solve this problem by providing plug-like sealing elements in the dismounting openings of the covering cap, but an additional component had to be kept at hand for this purpose and the installation time for installing the locking cylinder arrangement was extended.

### SUMMARY

An embodiment of the present disclosure proposes a locking cylinder arrangement, as well as a clamping device for such a locking cylinder arrangement, which has a simple construction and in which the risk of an air inflow is at least reduced.

A clamping device for a locking cylinder arrangement of a motor vehicle is disclosed which includes at least one clamping body, at least one receptacle arranged on the clamping body and in or on which a locking cylinder assembly such as a locking cylinder and/or a locking cylinder housing can be fixed. A first retaining element is arranged on the clamping body. A covering cap at least substantially covers the clamping device toward the outside on the side facing away from the locking cylinder and can be fixed by means of a second retaining element. A dismounting element is arranged on the clamping body and accessible from outside through a dismounting opening in the covering cap. The dismounting element can functionally cooperate with a dismounting means or release tool inserted through the dismounting opening in order to detach the covering cap. The dismounting element includes at least one edge element that extends in the direction of the covering cap, at least almost adjoins the covering cap and forms a hollow space that is almost exclusively accessible via the dismounting opening together with the covering cap.

With this concept, it is possible to arrange the locking cylinder in the door or in the hatch or swing panel of the motor vehicle without a housing. However, the locking cylinder may also be arranged in a locking cylinder housing. For example, the receptacle on the clamping body may include a recess, into which the locking cylinder and/or the locking cylinder housing can be inserted and fixed therein. Thus, as used herein, locking cylinder assembly refers to a locking cylinder with or without a housing.

In a section of a vehicle component such as a door, a swing panel or a hatch, the locking cylinder and/or the locking cylinder housing can be outwardly inserted through the vehicle component from the direction of the vehicle interior and secured fixed by means of the clamping body. In this case, the clamping body is supported relative to the vehicle component from outside such that the system consisting of the clamping body and the locking cylinder or the locking cylinder housing engages behind the vehicle component referred to the installation direction of the locking cylinder on both sides.

The dismounting means or release tool may basically include any component that serves for detaching the covering cap from the clamping device. The dismounting means or release tool may be realized, for example, in a rod-shaped fashion and include, in particular, a screwdriver, a vehicle key or the like. The dismounting element that functionally cooperates with the dismounting means or release tool is preferably realized in such a way that it can cooperate with this dismounting element in order to detach the covering cap.

Due to the fact that the covering cap includes at least one edge element that extends in the direction of the covering cap, at least almost adjoins the covering cap and forms a hollow space that is almost exclusively accessible via the dismounting opening together with the covering cap, an air inflow in the direction of the vehicle interior through the dismounting opening is at least reduced by means of the dismounting element. The dismounting element may further include an additional receptacle, in which the dismounting means or release tool can be arranged in order to detach the covering cap. However, this receptacle may be formed by the at least one edge element. This makes it possible to realize the clamping device in a compact fashion.

The risk of an air inflow can be additionally reduced if the edge element has an essentially closed frame-like cross section transverse to the direction in which it extends. The edge element may be realized in a meander-shaped or labyrinth-like fashion or includes several edge elements that respectively have a frame-like cross section and are arranged such that they surround one another.

The dismounting element with its edge element may furthermore be directly fixed on the clamping body. In this case, the hollow space formed together with the covering cap is enclosed by the covering cap, by the at least one edge element of the dismounting element and by the clamping body. In an embodiment of the clamping device, it is proposed that the dismounting element includes at least one bottom plate that is arranged on the side of the edge element that faces away from the covering cap and is or can be separably or inseparably fixed on the edge element, particularly by including a common component. If the dismounting element includes at least one bottom plate, the dismounting element can be used for different clamping devices with differently shaped clamping bodies without having to be adapted to the geometry of the clamping bodies. The risk of an air inflow can be additionally reduced if the edge element includes a plurality of edge sections that respectively extend essentially perpendicular to a surface section of the covering cap that is at least almost adjoined by the respective edge section.

The dismounting opening may further be arranged such that it at least partially overlaps with the edge element. In order to realize the dismounting opening provided in the covering cap as small as possible, however, it is advantageous if the edge element and the dismounting opening are in the installed state of the covering cap arranged without overlap viewed transverse to the direction in which the edge element extends.

The dismounting element may basically be arranged at any location of the clamping device. In order to provide an optically appealing exterior, however, it is advantageous to arrange the at least one dismounting element, particularly the at least one edge element, transverse or oblique to an inserting direction of the locking cylinder and/or the locking cylinder housing. In an exemplary embodiment of the clamping device, it is proposed that the dismounting element is arranged on a side that faces the vehicle floor. In this case, the dismounting opening in the covering cap also faces the vehicle floor. The dismounting element and the dismounting opening are in this case arranged in a region of the locking cylinder arrangement and of the motor vehicle that is almost optically indiscernible from outside and therefore contribute to an optically appealing exterior of the motor vehicle.

The covering cap may follow the design of a handle unit such as, e.g., a vehicle handle such that a clearance is formed between the covering cap and the clamping body, particularly on the side of the clamping body that faces away from the locking cylinder. In this case, it is advantageous if the dismounting element, particularly the edge element, protrudes over a surface facing away from the locking cylinder in the inserting direction and/or transverse or oblique thereto. If the edge element protrudes over the surface facing away from the locking cylinder in the inserting direction and/or transverse or oblique thereto, the dismounting element is arranged on the clamping body in an ear-like fashion.

The dismounting element may further include an offset in the inserting direction and/or transverse or oblique thereto in a surface that faces away from the locking cylinder. In this case, the clamping device can be realized in a compact fashion.

The dismounting element, the receptacle, the first retaining element and the clamping body may consist of separate or separable individual components. The clamping device can be cost-effectively manufactured if the dismounting element, the receptacle, the first retaining element and the clamping body include a common component, particularly a die-cast magnesium component.

While one dismounting element may be provided, an embodiment of the clamping device may include at least two dismounting elements arranged on the clamping body on opposite sides.

In order to further reduce the risk of an air inflow, at least one sealing means is provided in an embodiment of the clamping device and is or can be arranged between the edge element and the covering cap. The covering cap may include a second retaining element that can be fixed on the clamping body. The first retaining element and the second retaining element may basically be realized in any suitable way as long as they jointly ensure that the covering cap is fixed on the clamping body. It is advantageous if the first retaining element includes a recess, into which a second retaining element in the form of a hook can be snapped in order to separably engage behind the recess referred to the joining direction of the covering cap.

The present disclosure also provides a locking cylinder arrangement for a motor vehicle with at least one locking cylinder and/or with at least one locking cylinder housing, with at least one covering cap and with at least one clamping device, and including at least one of the aforementioned characteristics. In particular, the locking cylinder arrangement may include at least one clamping body, at least one receptacle that is arranged on the clamping body and in or on which a locking cylinder and/or a locking cylinder housing can be fixed, at least one first retaining element that is arranged on the clamping body and on or in which a covering cap that at least almost entirely covers the clamping device toward the outside on at least the side facing away from the locking cylinder can be fixed by means of at least one second retaining element, and at least one dismounting element that is arranged on the clamping body and accessible from outside through a dismounting opening in the covering cap. The dismounting element can functionally cooperate with a dismounting means or release tool inserted through the dismounting opening in order to detach the covering cap and includes at least one edge element that extends in the direction of the covering cap, at least almost adjoins the covering cap and forms a hollow space that is almost exclusively accessible via the dismounting opening together with the covering cap.

The present disclosure further provides a motor vehicle that features at least one locking cylinder arrangement, particularly with at least one of the aforementioned characteristics, and/or at least one clamping device, particularly with at least one of the aforementioned characteristics.

The clamping device, the locking cylinder arrangement and the motor vehicle provide advantages in several respects. Due to the fact that the dismounting element includes at least one edge element that at least almost adjoins the covering cap and forms a hollow space that is almost exclusively accessible via the dismounting opening together with the covering cap, the risk of an air inflow into the vehicle interior through the dismounting opening of the locking cylinder arrangement is at least reduced. The air inflow risk is additionally reduced due to the fact that the at least one edge element has an essentially closed frame-like cross section transverse to the direction in which it extends.

Other characteristics, details and advantages result from the attached claims, as well as the graphic illustrations and the following description of a preferred embodiment of the clamping device and the locking cylinder arrangement.

### BRIEF DESCRIPTION OF THE DRAWINGS

The present disclosure will hereinafter be described in conjunction with the following drawing figures, wherein like numerals denote like elements.

FIG. 1 shows a perspective side view of a locking cylinder arrangement with clamping device and covering cap;

FIG. 2 shows a sectioned perspective top view of the locking cylinder arrangement according to FIG. 1, and

FIG. 3 shows a sectioned detail of a dismounting element according to FIG. 2.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The figures show a locking cylinder arrangement for a motor vehicle that is collectively identified by the reference symbol 2. The locking cylinder arrangement 2 includes a clamping device 4 and a covering cap 6. The locking cylinder arrangement 2 also includes a locking cylinder that is not illustrated in the figures and/or a locking cylinder housing that is not illustrated in the figures and can be fixed by means of the clamping device 4. The clamping device 4 includes a clamping body 8, in which a receptacle 10 in the form of a recess is arranged. The locking cylinder and/or the locking cylinder housing of the locking cylinder arrangement 2 can be fixed in or on the receptacle 10.

In addition, the clamping body 8 is provided with a first retaining element 12, on which the covering cap 6 can be fixed by means of a second retaining element 14. The first retaining element 12 and the second retaining element 14 are realized in the form of a projection and an offset such that the projection and can engage behind the offset referred to the installation direction of the covering cap 6 when the retaining elements are connected to one another.

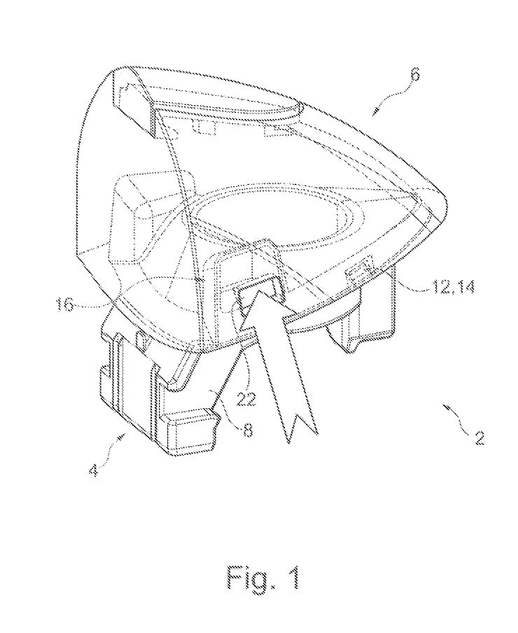

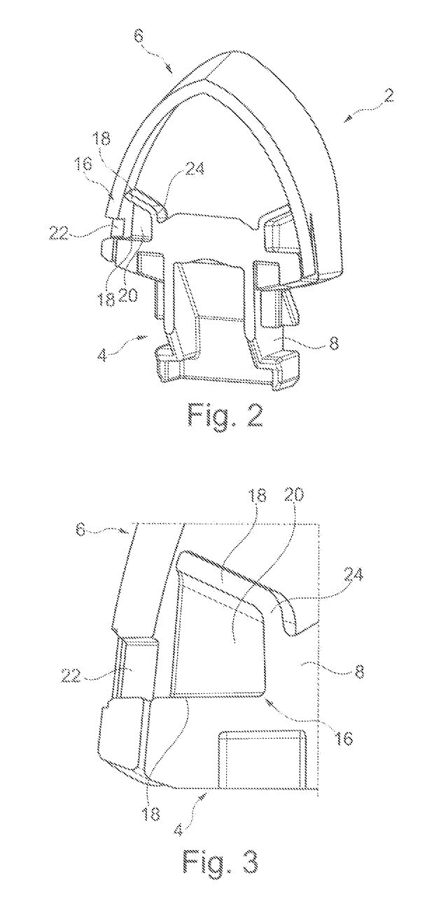

In order to once again detach the covering cap 6 from the clamping body 8, the clamping device 4 includes a dismounting element 16 that is arranged on the clamping body 8. The dismounting element 16 includes an edge element 18 that extends in the direction of the covering cap, at least almost adjoins the covering cap 6 and forms a hollow space 20 that is almost exclusively accessible via a dismounting opening 22 in the covering cap 6 together with the covering cap 6. A dismounting means or release tool (schematically illustrated as an arrow in FIG. 1) can be inserted through the dismounting opening 22 and functionally cooperate with the dismounting element 16 in order to remove the covering cap 6 from the clamping body 8.

The edge element 18 is realized in such a way that it has an essentially closed frame-like cross section transverse to the direction in which it extends toward the covering cap 6. In the embodiment illustrated in the figures, a bottom plate 24 that defines the dismounting element 16 is provided on the side of the edge element 18 that faces away from the covering cap 6.

In the exemplary embodiment illustrated in the figures, the dismounting element 16, the receptacle 10, the first retaining element 12 and the bottom plate 24 are formed by a common component, particularly a die-cast magnesium component.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-13. (canceled)

14. A clamping device for a locking cylinder assembly arrangement of a motor vehicle comprising:
a clamping body having a receptacle configured to fixedly receive a locking cylinder assembly;
a first retaining element arranged on the clamping body;
a covering cap that at least almost entirely covers the clamping device toward an outside on a side facing away from the locking cylinder assembly;
a second retaining element cooperating with the first retaining element to secure the covering cap; and
a dismounting element arranged on the clamping body and accessible from outside through a dismounting opening in the covering cap, wherein the dismounting element is configured to cooperate with a release tool inserted through the dismounting opening in order to detach the covering cap, the dismounting element further including an edge element that extends in the direction of the covering cap, at least almost adjoins the covering cap and forms a hollow space that is almost exclusively accessible via the dismounting opening together with the covering cap.

15. The clamping device according to claim 14, wherein the edge element has an essentially closed frame-like cross section transverse to the direction in which it extends.

16. The clamping device according to claim 14, wherein the dismounting element further comprises a bottom plate arranged on the side of the edge element facing away from the covering cap and fixed on the edge element.

17. The clamping device according to claim 14, wherein the edge element comprises a plurality of edge sections that respectively extend essentially perpendicular to a surface section of the covering cap and that is at least almost adjoined by the respective edge section.

18. The clamping device according to claim 14, wherein the edge element and the dismounting opening are arranged without overlap when in the installed state of the covering cap viewed transverse to the direction in which the edge element extends.

19. The clamping device according to claim 14, wherein the edge element is arranged oblique to the inserting direction of the locking cylinder assembly.

20. The clamping device according to claim 14, wherein the edge element is arranged transverse to the inserting direction of the locking cylinder assembly.

21. The clamping device according to claim 14, wherein the edge element of the dismounting element protrudes over a surface facing away from the locking cylinder assembly in the inserting direction, and wherein the dismounting element further comprises an offset in the inserting direction in a surface that faces away from the locking cylinder assembly.

22. The clamping device according to claim 14, wherein the dismounting element, the receptacle, the first retaining element and the clamping body comprise a unitary component.

23. The clamping device according to claim 14, wherein the unitary component is a die-cast component.

24. The clamping device according to claim 14 further comprising at least two dismounting elements such that the clamping body has at least one dismounting element arranged on opposite sides thereof.

25. The clamping device according to claim 14 further comprising a seal arranged between the edge element and the covering cap.

26. The clamping device according to claim 14, wherein the first retaining element comprises a recess, into which the second retaining element in the form of a hook can be inserted to separably engage behind the recess in reference to the joining direction of the covering cap.

27. A locking cylinder arrangement for a motor vehicle comprising:
a locking cylinder assembly having at least one of a locking cylinder and a locking cylinder housing; and
a clamping device including:
a clamping body having a receptacle fixedly receiving a locking cylinder assembly;
a first retaining element arranged on the clamping body;
a covering cap that at least almost entirely covers the clamping device toward an outside on a side facing away from the locking cylinder assembly;
a second retaining element cooperating with the first retaining element to secure the covering cap; and
a dismounting element arranged on the clamping body and accessible from outside through a dismounting opening in the covering cap, wherein the dismounting element is configured to cooperate with a release tool inserted through the dismounting opening in order to detach the covering cap, the dismounting element further including an edge element that extends in the direction of the covering cap, at least almost adjoins the covering cap and forms a hollow space that is almost exclusively accessible via the dismounting opening together with the covering cap.

28. A motor vehicle with at least one locking cylinder assembly arrangement according to claim 27.
